(19) United States
(12) Patent Application Publication
(10) Pub. No.: US 2008/0035763 A1
(43) Pub. Date: Feb. 14, 2008

(54) Manure loading and spreading trailer

(76) Inventor: Shad Dahlgren, Lincoln, NE (US)

Correspondence Address: LAW OFFICES OF ADAM H. JACOBS;PATENT ATTORNEY, SUITE 726, 1904 FARNAM STREET, OMAHA, NE, 68102, US

(21) Appl. No.: 11/888,693

(22) Filed: Aug. 2, 2007

Related U.S. Application Data
(60) Provisional application No. 60/837,415, filed on Aug. 11, 2006.

(51) Int. Cl. A01C 3/04; A01C 3/06

(52) U.S. Cl. 239/651

(57) ABSTRACT

A manure loading and spreading trailer includes a trailer chassis having at least two wheels rotatably mounted thereon and a trailer body mounted on the trailer chassis which includes a forward scoop section having an open forward face into which manure on the ground is scooped. A paddle scraper is mounted adjacent the forward scoop section within the trailer body for engaging and transferring manure scooped into the forward scoop section into the trailer body, and a trailer body conveyor belt is mounted on the base of the trailer body for transferring the manure from the forward scoop section rearwards towards the rear of the trailer body. A manure spreader is mounted on the rear of the trailer body, the manure spreader operative to engage manure being fed rearwards on the conveyor belt and spread the manure behind the trailer body thereby utilizing the manure collected by the trailer.

### CROSS-REFERENCE TO RELATED PATENTS

This application claims priority based on a provisional patent, specifically on the Provisional Patent Application Ser. No. 60/837,415 filed Aug. 11, 2006.

### BACKGROUND OF THE INVENTION

1. Technical Field

The present invention relates to manure gathering and spreading devices and, more particularly, to a manure loading and spreading trailer adapted to be towed behind a truck or tractor which includes a trailer chassis having at least two wheels rotatably mounted thereon, a forwardly-extending trailer tongue connected to the trailer chassis for connection to a towing vehicle, a trailer body which includes a forward scoop section having an open forward face into which manure on the ground is scooped, a paddle scraper mounted adjacent the forward scoop section for engaging and transferring manure scooped into the forward scoop section into the trailer body, a trailer body conveyor belt mounted on the base of the trailer body for transferring the manure from the forward scoop section rearwards to the back of the trailer body and a manure spreader mounted on the rear of the trailer body which engages manure being fed to the manure spreader by the conveyor belt and spreads the manure behind the trailer to utilize the manure collected by the present invention.

2. Description of the Prior Art

For years farmers have had to deal with the task of removing manure from animal feeding pens. Several different devices and vehicles have been used to perform this task, including tractors, scrapers, floats, loaders and other devices. Generally, the farmer would use a box scraper or blade to scrape the manure into a pile, then use a second machine such as a bucket loader or the like to lift the manure into a manure spreader. The manure spreader would then be driven to a crop field and the manure hauled therein would be spread to fertilize the field. Unfortunately, this system is quite inefficient, as several different vehicles are used in gathering, loading, transporting and spreading the manure, and further that the system actually removes some of the topsoil from the animal feeding pen due to the method of use of the box scraper. The feeding pen then becomes unable to properly drain, which results in trapped water and therefore increases the distress on the animals.

Numerous devices are found in the prior art which attempt to address and correct this problem, including Martin, U.S. Pat. No. 4,438,885, and Omann, U.S. Pat. No. 5,664,348, each of which disclose material loading devices adapted for use with the loading of manure into a transport device. However, each of these prior art devices still require the user to transfer the manure to at least a second vehicle for spreading thereof, and therefore remain inefficient. Furthermore, these prior art devices generally are designed for the loading of manure only, and are not adept at scraping and gathering the manure in the feed lot, which is an important element of the cleaning and clearing of the feeding lot. There is therefore a need for an improved manure loading and spreading trailer which can be towed behind a powered vehicle and will pick up manure, transport it and spread it without requiring transfer of the manure to another vehicle.

Therefore, an object of the present invention is to provide an improved manure loading and spreading trailer.

Another object of the present invention is to provide an improved manure loading and spreading trailer which includes a forward scoop which engages and scoops manure on the ground up into the trailer body, a set of paddle scrapers which engage and move the manure into the trailer body, a trailer manure conveyor for moving the manure rearwards within the trailer body and a manure spreader on the rear of the trailer body for spreading the manure behind the trailer.

Another object of the present invention is to provide an improved manure loading and spreading trailer which can be used for the gathering of many different kinds of manure in many different situations.

Another object of the present invention is to provide an improved manure loading and spreading trailer which will generally eliminate the need for two or more separate devices for gathering, moving and spreading of manure.

Finally, an object of the present invention is to provide improved manure loading and spreading trailer which is relatively simple and durable in construction and is safe, efficient and effective in use.

### SUMMARY OF THE INVENTION

The present invention provides a manure loading and spreading trailer adapted to be towed behind a motorized vehicle, the trailer including a trailer chassis having at least two wheels rotatably mounted thereon and a forwardly-extending trailer tongue connected to the trailer chassis for connection to a towing vehicle. A trailer body is mounted on the trailer chassis and includes a forward scoop section having an open forward face into which manure on the ground is scooped, and a paddle scraper is mounted adjacent the forward scoop section within the trailer body for engaging and transferring manure scooped into the forward scoop section into the trailer body, the paddle scraper including a plurality of scraping paddles extending generally perpendicularly to the center longitudinal axis of the trailer body, the plurality of scraper paddles operative to engage manure entering the forward scoop section and force the manure into the trailer body. A trailer body conveyor belt is mounted on the base of the trailer body for transferring the manure from the forward scoop section rearwards towards the rear of the trailer body and a manure spreader is mounted on the rear of the trailer body, the manure spreader operative to engage manure being fed rearwards on the conveyor belt and spread the manure behind the trailer body thereby utilizing the manure collected by the trailer.

The present invention as thus described provides a significant advantage over those manure gathering devices found in the prior art. For example, there is no further need for transferring the gathered manure to a second vehicle for spreading thereof, as the trailer of the present invention is capable of fulfilling both functions of those devices in the prior art. Furthermore, because the trailer of the present invention effectively replaces two or even three farm implements with a single device, it will save the user of the present invention substantial amounts of time and money. Finally, because the trailer of the present invention provides an easy and efficient device for the gathering and spreading of all different types of manure, it may be used in many different situations by many different farmers and livestock raisers regardless of the type of manure being gathered and spread. It is therefore seen that the present invention provides a substantial improvement over those devices and methods found in the prior art.

### BRIEF DESCRIPTION OF THE DRAWINGS

FIG. 1 is a perspective view of the manure loading and spreading trailer of the present invention;

FIG. 2 is a side elevational view of the present invention in travel position with the forward scoop section raised above the ground surface over which the trailer is traveling;

FIG. 3 is a side elevational view of the trailer with the trailer in scooping position with the forward scoop section engaging and collecting manure as the trailer is towed;

FIG. 4 is a detailed side elevational view of the forward scoop section and paddle scraper working to scrape manure from the field or feed lot and load it into the trailer body;

FIG. 5 is a detailed side elevational view of the rear of the manure loading and spreading trailer of the present invention showing how the rear gate would be lifted to permit the manure to enter the manure spreader which distributes the manure throughout the field being fertilized; and

FIGS. 6 and 7 are detailed perspective views of the rear of the trailer with the embodiment of FIG. 6 showing a standard manure spreader configuration and the embodiment of FIG. 7 showing a composting configuration in which a composting hood prevents manure from being flung upwards and outwards from the rear of the trailer.

### DESCRIPTION OF THE PREFERRED EMBODIMENT

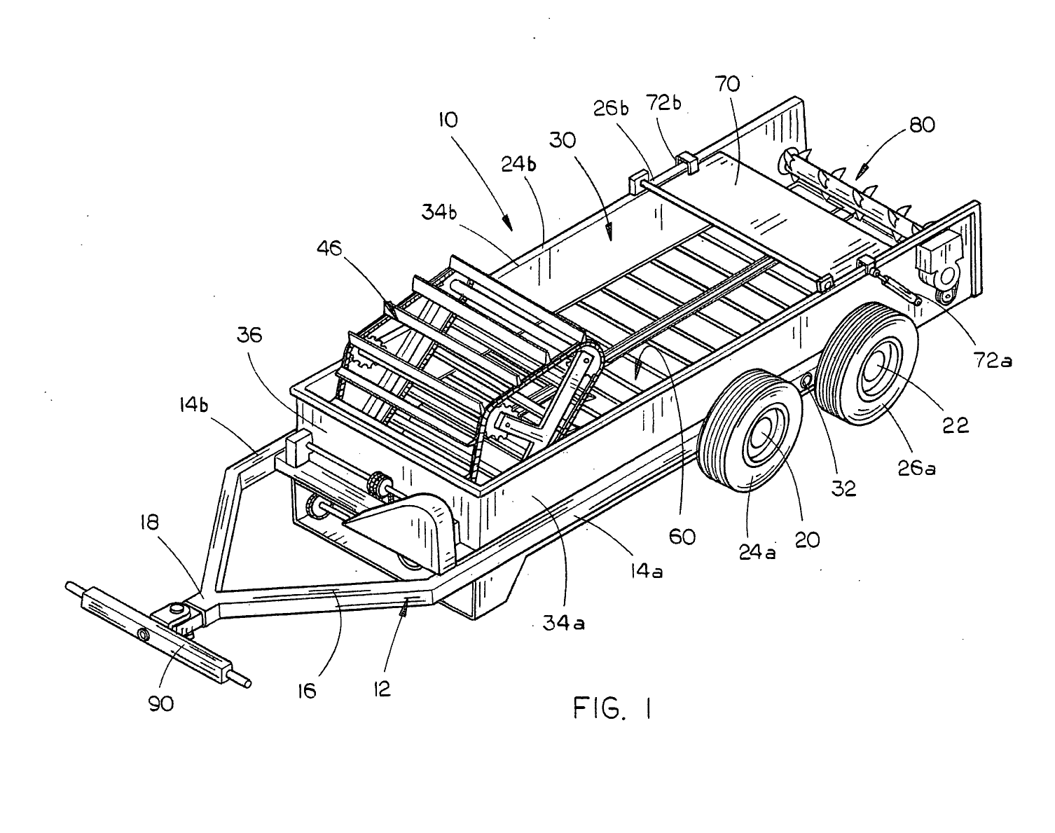

The manure loading and spreading trailer 10 of the present invention is shown best in FIGS. 1-5 as including a trailer chassis 12 which includes left and right chassis bars 14a and 14b, a generally Y-shaped forward tongue support beam 16 which extends between and connects the chassis bars adjacent the front end of the trailer chassis 12, and a trailer tongue 18 which extends forwards from the forward tongue support beam 16 for connection to a towing vehicle. In the preferred embodiment, the trailer chassis 12 would be constructed of heavy gauge rectangular steel tubing, although it should be noted that the exact size, shape and dimensions of the trailer chassis 12 are not critical to the present invention so long as the functional features of the trailer chassis 12 in supporting the manure loading and spreading trailer 10 are maintained. In fact, the left and right chassis bars 14a and 14b may be positioned underneath the trailer body or outside of the body as shown, depending on the structural design requirements of the present invention.

Mounted on the trailer chassis 12 is a wheel support frame 19 on which are rotatably mounted a pair of axles 20 and 22 on which are mounted trailer wheels 24a, 24b, 26a and 26b, as shown in FIG. 1. Of course, the manure loading and spreading trailer 10 of the present invention may include only a single axle and pair of wheels, depending on the structural strength of the axle, but it has been found that a dual axle trailer provides the desired structural stability for the trailer chassis 12 while also maintaining a relatively smooth ride for the manure loading and spreading trailer 10. In the preferred embodiment, trailer wheels 24a, 24b, 26a and 26b would be standard rubber tires of the type commonly used with trailers.

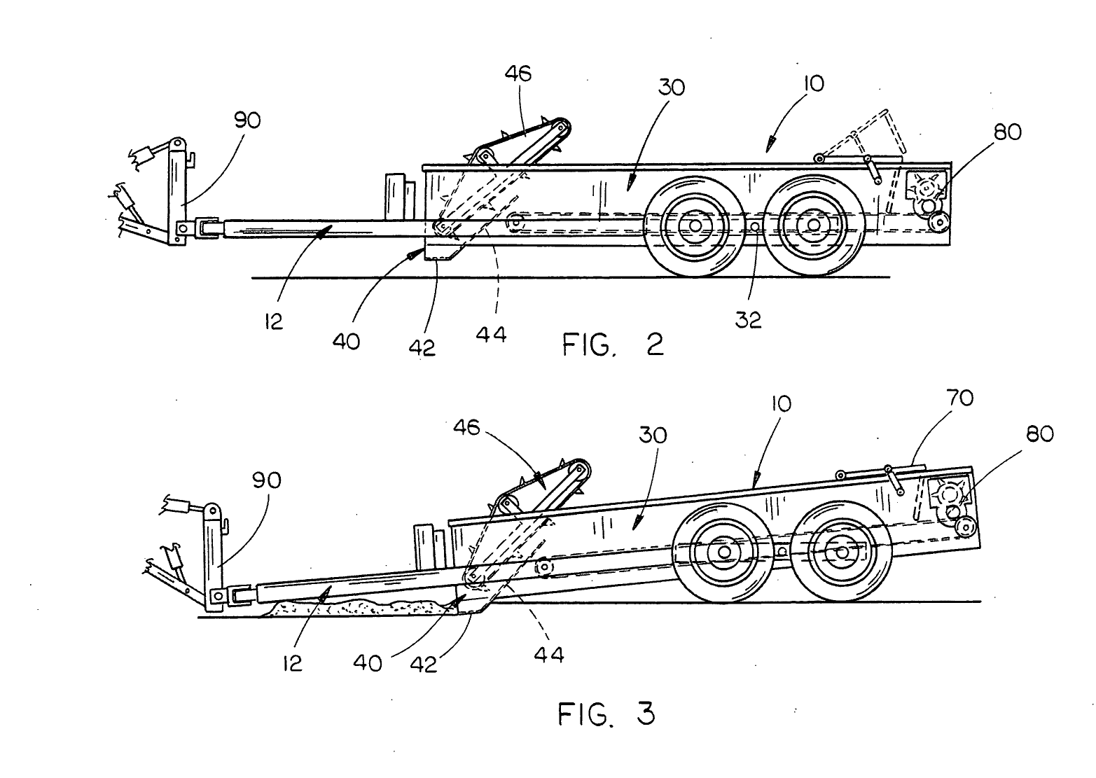

A trailer body 30 is mounted on the trailer chassis 12 with the trailer body 30 and the trailer chassis being pivotably mounted on the wheel support frame 19 via a pivot mount axle 32 which is positioned generally adjacent the axles 20 and 22, as shown best in FIG. 1. In the preferred embodiment, the trailer body 30 would be shaped as a generally rectangular box having an open top, with side walls 34a and 34b, front wall 36, and base wall 38, and would preferably be constructed of a heavy-gauge rolled sheet metal or the like. The trailer body 30 and trailer chassis 12 would be pivoted about the pivot mount axle 32 by actuation of a three point hitch 90 mounted on the tractor or other such towing vehicle, the three point hitch 90 being of a standard type commonly found on tractors and the like which includes a plurality of hydraulic cylinders which lift and lower the trailer hitch relative to the tractor, thus raising and lowering the trailer tongue 18 as shown in FIGS. 2 and 3. Alternatively, the present invention could incorporate a forward hydraulic cylinder (not shown) which extends between the trailer chassis 12 and the front end of the trailer body 30 to pivot the trailer body 30 relative to the trailer chassis 12, although it has been found that the use of the three point hitch 90 for raising and lowering the trailer tongue 18 performs this task quite efficiently. In either embodiment, however, the trailer body 30 pivots between a horizontally disposed travel position as shown in FIG. 2 and a downwardly tilted scoop position as shown in FIG. 3 wherein the trailer body 30 is in position to scoop and retain manure encountered by the trailer body 30 as the trailer is moved forward, as will be described in more detail later in this disclosure.

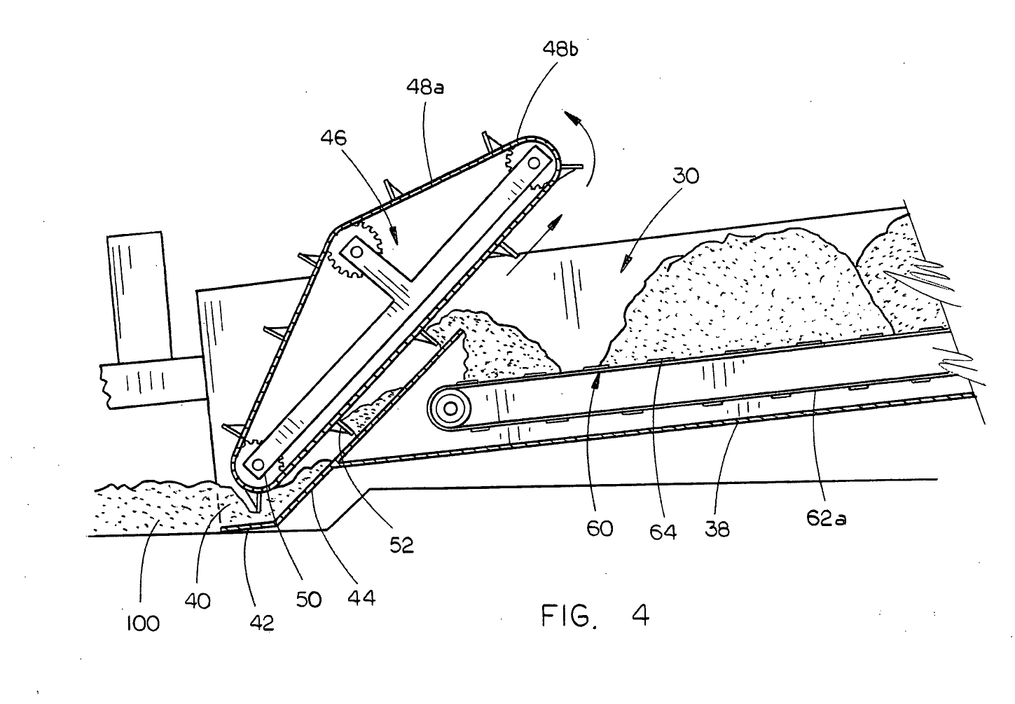

Front wall 36 of trailer body 30 would further include a forward scoop section 40 which, in the preferred embodiment, would include a lower cutting blade 42 which is a generally flat horizontal plate positioned below and forward of base wall 38, as shown best in FIG. 4, and an upwardly sloping feed wall 44 connected to the rear end of the lower cutting blade 42 which extends upwards and rearwards therefrom to a position above the base wall 38 so that manure which enters the forward scoop section 40 via contact with the lower cutting blade 42 is directed upwards and rearwards via the feed wall 44 into the body of the trailer body 30. When the trailer body 30 is pivoted downwards into its downwardly tilted scoop position as shown in FIG. 3, the lower cutting blade 42 is positioned adjacent or below the ground surface and manure that is sitting on the ground surface in front of the direction of travel of the trailer 10 is scooped into the trailer body 30 via the lower cutting blade 42 and upwardly sloping feed wall 44.

However, it is clear that some sort of feed mechanism is necessary to transfer the manure from the lower area of the forward scoop section 40 rearwards into the body of the trailer body 30, and therefore the present invention includes a paddle scraper 46 which, in the preferred embodiment, includes a generally T-shaped frame 47 extending the width of the forward scoop section 40 on which are mounted left and right paddle scraper support chains 48a and 48b which are rotatably mounted on the T-shaped frame 47 by a plurality of rotating gears 50. The paddle scraper 46 further includes a plurality of scraping paddles 52 which extend between and connect the paddle scraper support chains 48a and 48b and extend generally perpendicularly outward from the paddle scraper support chains 48a and 48b, as shown best in FIGS. 1 and 4.

As the paddle scraper support chains 48a and 48b are rotated by their connection to a power take-off (PTO) or the like, the plurality of scraping paddles 52 are rotated as shown in FIG. 4, and as the trailer 10 moves forward and scoops up manure via the lower cutting blade 42 and upwardly sloping feed wall 44, the manure 100 is engaged by the plurality of scraping paddles 52 which force the manure 100 up and over the feed wall 44 into the trailer body 30. The paddle scraper 46 thus draws the manure 100 into the trailer body 30, and it should be noted that the size of the paddle scraper 46 and elements thereof may be modified or changed in order to increase or decrease the amount of manure 100 being transferred from the front of the forward scoop section 40 to the interior of the trailer body 30, and such modifications would be understood by one skilled in the art of paddle scrapers.

As the manure 100 falls over the top end of the feed wall 44, the manure falls onto a trailer body conveyor belt or chain mechanism 60 mounted on the base wall 38 of the trailer body 30 which is operative to move the manure 100 from the front of the trailer body 30 to the rear of the trailer body 30, as shown best in FIGS. 1, 4 and 5. It is preferred that the trailer body conveyor belt mechanism 60 include at least two generally parallel conveyor belt chains 62a and 62b rotatably mounted on the base wall 38 and extending generally parallel with the longitudinal axis of the trailer body 30. Extending generally perpendicularly between the conveyor belt chains 62a and 62b are a plurality of metal cross bars 64 which generally serve the same function as the plurality of scraping paddles 52 of the paddle scraper 46 as described above in that the cross bars 64 engage the manure 100 as the conveyor belt chains 62a and 62b rotate and transfer the manure 100 from the front of the trailer body 30 to the rear. The trailer body conveyor belt mechanism 60 may also be referred to as a horizontal chain, but the important consideration for the trailer body conveyor belt mechanism 60 is that it function in a manner similar to that described above in connection with the paddle scraper 46 for transfer of the manure 100. Also, it may be beneficial to include more than one conveyor belt mechanism 60 on the base wall 38 of the trailer body 30, as shown in FIG. 1, where two conveyor belt mechanisms 60 and 61 are shown in side-by-side longitudinally parallel configuration to ensure that the manure 100 entering the trailer body 30 via the forward scoop section 40 is efficiently transferred to the rear of the trailer body 30.

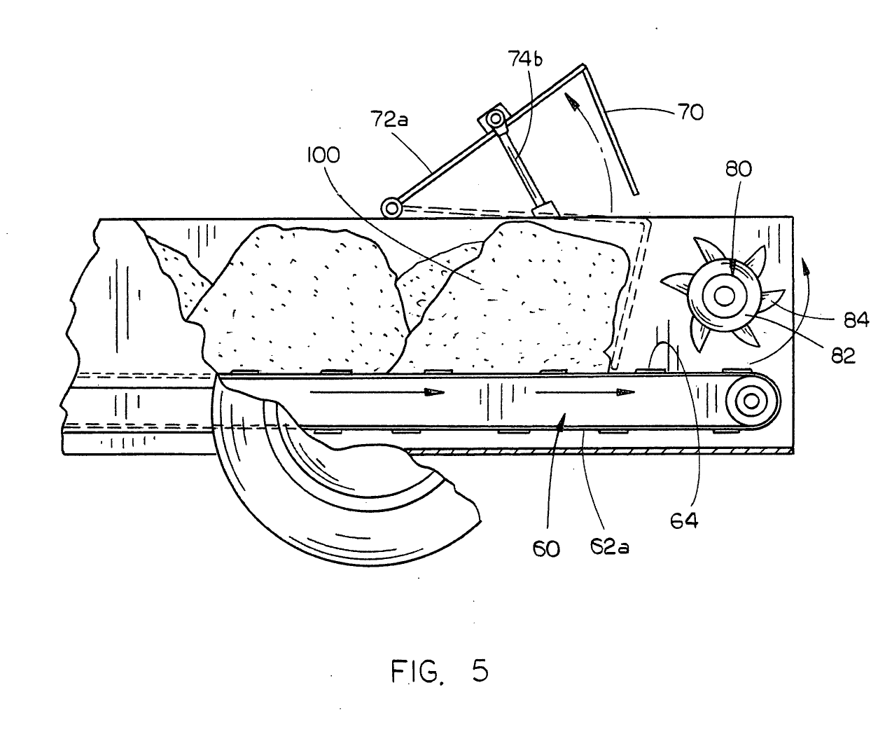

As the manure 100 is moved to the rear of the trailer body 30, as shown in FIG. 5, it is stopped by the rear gate 70 which extends perpendicularly across the trailer body 30 between the side walls 34a and 34b. The rear gate 70 is preferably a steel plate having a width approximately equal to the distance between the side walls 34a and 34b and a height approximately equal to the height of the side walls 34a and 34b above the trailer body conveyor belt mechanism 60. The rear gate 70 is pivotably mounted on the trailer body 30 as shown in FIG. 5 by connection to a pair of pivot arms 72a and 72b which are pivotably mounted on top of the side walls 34a and 34b, and a pair of hydraulic cylinders 74a and 74b are connected to the pivot arms 72a and 72b to pivot the rear gate 70 upwards and downwards.

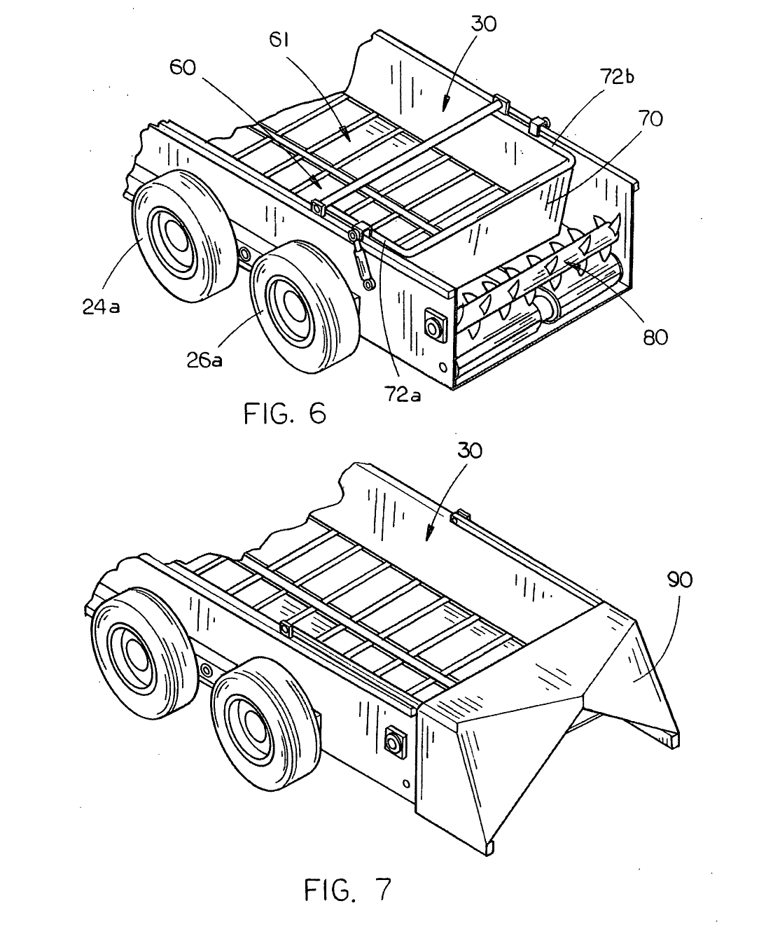

Mounted on the rear of the trailer body 30 behind the rear gate 70, as shown best in FIGS. 5 and 6, is a manure spreader 80 which, in the preferred embodiment, would include a rotating shaft 82 on which are mounted a plurality of beater paddles 84 which are designed to engage the manure 100 and expel it onto the area rearwards of the trailer 10. It is preferred that the manure spreader 80 function in a manner similar to other manure spreaders currently found in the art, and therefore further discussion of the operational characteristics of the manure spreader 80 will not be undertaken in this disclosure.

When the rear gate 70 is in the down position, manure 100 is gathered in the trailer body 30 for storage and transport. Upon the rear gate 70 being lifted via the hydraulic cylinders 74a and 74b, however, the manure 100 is transferred rearwards via the trailer body conveyor belt mechanism 60 towards the manure spreader 80 and as the manure 100 enters the rotating beater paddles 84, it is flung rearwards and outwards from the trailer 10 thereby fertilizing the field over which the trailer 10 is being transported.

The trailer 10 would be loaded in the following manner:

The trailer 10 is pulled forward via a towing vehicle and upon reaching a location where soil or manure 100 is to be gathered, the trailer body 30 is pivoted downwards via the three point hitch 90 into the scoop position as shown in FIG. 3 wherein the trailer body 30 is in position to scoop and retain manure encountered by the trailer body 30 as the trailer is moved forward. As the lower cutting blade 42 comes in contact with soil or manure 100, it scrapes up material to where the rotating plurality of scraping paddles 52 of the paddle scraper 46 lift the manure 100 into the trailer body 30 through contact with the feed wall 44. This process continues until a pile of manure 100 develops in the trailer body 30 to the height of the top of the paddle scraper 46, at which time the operator would engage the trailer body conveyor belt mechanism 60 and the pile of manure 100 is moved towards the rear of the trailer body until there is enough room for the next pile to gather. The trailer body conveyor belt mechanism 60 is then disengaged until the next pile is gathered. This step is necessary to ensure that a full load is obtained.

Once the trailer body is full, it is then raised by the three point hitch 90 into the transport position as shown in FIG. 2 and the paddle scraper 46 is then likewise disengaged. The manure loading and spreading trailer 10 is then driven to the desired unloading area and the manure 100 is then readied for distribution. During the unloading process, the rear gate 70 is raised via the hydraulic cylinders 74a and 74b and the manure 100 is fed to the rear of the trailer body 30 via the trailer body conveyor belt mechanism 60 so that the manure 100 is fed into the manure spreader 80. The rotating shaft 82 drives the beater paddles 84 to engage the manure 100 and fling it out of the trailer body 30 onto the field being fertilized. As the trailer 10 is pulled forwards, the manure 100 is spread over the field and once the manure 100 has been unloaded from the trailer body 30, the trailer 10 can be taken back to the loading area for further loading and operation.

An alternative unloading method is shown best in FIG. 7 in which the manure 100 would be unloaded for a composting process. The rear gate 70 may be removed and replaced with a composting hood 90 which is mounted over the manure spreader 80 to prevent the “flinging” of material from the manure spreader 80. Instead, the manure 100 would be loaded and unloaded at the same time by the operator driving over the existing compost windrow with the trailer body in the scoop position thus loading the manure 100 and simultaneously unloading the manure 100 to place it back in the field in a windrow.

It is to be understood that numerous additions, modifications and substitutions may be made to the manure loading and spreading trailer 10 of the present invention which fall within the intended broad scope of the above description. For example, the size, shape and construction materials used in connection with the various elements of the manure loading and spreading trailer 10 may be modified or changed so long as the intended functional characteristics are neither degraded nor destroyed. Furthermore, it is expected that the load capacities of the specific functional elements of the present invention will vary depending on the volume and consistence of the manure 100 to be picked up, transported and spread by the manure loading and spreading trailer 10, and experimentation with those elements within certain ranges is understood to be a part of this disclosure. Also, although the present invention has been described as being used primarily for the gathering, transporting and distributing of manure, virtually any solid granular or chunk material can be processed by the trailer 10 of the present invention. Finally, it should be noted that although the present invention has been described as being incorporated into a trailer, it is entirely possible that the present invention can be incorporated into a self-propelled vehicle, and such modifications shall be understood to be a part of this disclosure.

There has therefore been shown and described a manure loading and spreading trailer 10 which accomplishes at least all of its intended objectives.

I claim:

1. A manure loading and spreading trailer adapted to be towed behind a motorized vehicle, said trailer comprising:
a trailer chassis having at least two wheels rotatably mounted thereon;
a forwardly-extending trailer tongue connected to the trailer chassis for connection to a towing vehicle;
a trailer body mounted on said trailer chassis, said trailer body including a forward scoop section having an open forward face into which manure on the ground is scooped;
a paddle scraper mounted adjacent the forward scoop section within said trailer body for engaging and transferring manure scooped into the forward scoop section into the trailer body, said paddle scraper including a plurality of scraping paddles extending generally perpendicularly to the center longitudinal axis of said trailer body, said plurality of scraper paddles operative to engage manure entering said forward scoop section and force the manure into said trailer body;
a trailer body conveyor belt mounted on the base of the trailer body for transferring the manure from said forward scoop section rearwards towards the rear of said trailer body; and
a manure spreader mounted on said rear of said trailer body, said manure spreader operative to engage manure being fed rearwards on said conveyor belt and spread the manure behind said trailer body thereby utilizing the manure collected by said trailer.

2. The manure loading and spreading trailer of claim 1 wherein said trailer body is pivotably mounted on said trailer chassis such that said trailer body pivots between a generally horizontally disposed travel position and a downwardly tilted scoop position wherein said trailer body is positioned to scoop and retain manure encountered by said open forward face of said forward scoop section on said trailer body as said trailer is moved forwards.

3. The manure loading and spreading trailer of claim 1 wherein said paddle scraper includes a generally T-shaped frame extending the width of said forward scoop section on which are mounted left and right paddle scraper support chains which are rotatably mounted on said T-shaped frame by a plurality of rotating gears, said plurality of scraping paddles extending between and connecting said paddle scraper support chains and each extending generally perpendicularly outward from said paddle scraper support chains such that as said paddle scraper support chains are rotated, said plurality of scraping paddles are rotated to engage the incoming manure and force the manure into said trailer body.

4. The manure loading and spreading trailer of claim 1 wherein said trailer body conveyor belt includes at least two generally parallel conveyor belt chains rotatably mounted on the base wall of said trailer body which extend generally parallel with said center longitudinal axis of said trailer body and a plurality of cross bars which extend generally perpendicularly between and connect said conveyor belt chains whereby said cross bars engage the manure as said at least two conveyor belt chains rotate to transfer the manure from the front of said trailer body to said rear of said trailer body.

5. The manure loading and spreading trailer of claim 1 wherein said manure spreader includes a rotating shaft on which are mounted a plurality of outwardly-extending beater paddles which engage the manure moved to the rear of said trailer body and expel it onto the area rearwards of said trailer.

6. A manure loading and spreading trailer adapted to be towed behind a motorized vehicle, said trailer comprising:
a trailer chassis having at least two wheels rotatably mounted thereon;
means for connecting said trailer chassis to a towing vehicle;
a trailer body mounted on said trailer chassis, said trailer body including a forward scoop section having an open forward face into which manure on the ground is scooped, said trailer body being pivotably mounted on said trailer chassis such that said trailer body pivots between a generally horizontally disposed travel position and a downwardly tilted scoop position wherein said trailer body is positioned to scoop and retain manure encountered by said open forward face of said forward scoop section on said trailer body as said trailer is moved forwards;
a paddle scraper mounted adjacent the forward scoop section within said trailer body for engaging and transferring manure scooped into the forward scoop section into the trailer body, said paddle scraper including a plurality of scraping paddles extending generally perpendicularly to the center longitudinal axis of said trailer body, said plurality of scraper paddles operative to engage manure entering said forward scoop section and force the manure into said trailer body;
a trailer body conveyor belt mounted on the base of the trailer body for transferring the manure from said forward scoop section rearwards towards the rear of said trailer body; and
a manure spreader mounted on said rear of said trailer body, said manure spreader operative to engage manure being fed rearwards on said conveyor belt and spread the manure behind said trailer body thereby utilizing the manure collected by said trailer.

7. The manure loading and spreading trailer of claim 6 wherein said paddle scraper includes a generally T-shaped frame extending the width of said forward scoop section on which are mounted left and right paddle scraper support chains which are rotatably mounted on said T-shaped frame by a plurality of rotating gears, said plurality of scraping paddles extending between and connecting said paddle scraper support chains and each extending generally perpendicularly outward from said paddle scraper support chains such that as said paddle scraper support chains are rotated, said plurality of scraping paddles are rotated to engage the incoming manure and force the manure into said trailer body.

8. The manure loading and spreading trailer of claim 6 wherein said trailer body conveyor belt includes at least two generally parallel conveyor belt chains rotatably mounted on the base wall of said trailer body which extend generally parallel with said center longitudinal axis of said trailer body and a plurality of cross bars which extend generally perpendicularly between and connect said conveyor belt chains whereby said cross bars engage the manure as said at least two conveyor belt chains rotate to transfer the manure from the front of said trailer body to said rear of said trailer body.

9. The manure loading and spreading trailer of claim 6 wherein said manure spreader includes a rotating shaft on which are mounted a plurality of outwardly-extending beater paddles which engage the manure moved to the rear of said trailer body and expel it onto the area rearwards of said trailer.
